(19) United States
(12) Patent Application Publication
(10) Pub. No.: US 2002/0158947 A1
(43) Pub. Date: Oct. 31, 2002

(54) Piezoelectric element, method for manufacturing piezoelectric element, and ink jet head and ink jet recording apparatus having piezoelectric element

(76) Inventors: Isaku Kanno, Nara (JP); Keiichiro Yamanaka, Kanagawa (JP); Takeshi Kamada, Nara (JP); Hiroyoshi Yajima, Kanagawa (JP); Shintaro Hara, Fukuoka (JP)

Correspondence Address: HARNESS, DICKEY & PIERCE, P.L.C., P.O. BOX 828, BLOOMFIELD HILLS, MI, 48303, US

(21) Appl. No.: 10/127,125

(22) Filed: Apr. 22, 2002

(30) Foreign Application Priority Data
Apr. 27, 2001 (JP) 2001-131413

(51) Int. Cl. B41J 2/045

(52) U.S. Cl. 347/70

(57) ABSTRACT

A piezoelectric film and a second electrode and vibration plate are formed on one surface of a deposition substrate that transmits ultraviolet rays therethrough. A transfer substrate is attached to the second electrode and vibration plate. The other surface of the deposition substrate is irradiated with ultraviolet rays. The deposition substrate and the piezoelectric film are separated from each other by the energy of the ultraviolet rays, thus transferring the piezoelectric film and the second electrode and vibration plate onto the transfer substrate.

### BACKGROUND OF THE INVENTION

1. Field of the Invention

The present invention relates to a piezoelectric element, a method for manufacturing a piezoelectric element, and an ink jet head and an ink jet recording apparatus having a piezoelectric element.

2. Description of the Background Art

Referring to FIG. 10 to FIG. 13, a conventional piezoelectric element, a manufacturing method therefor and an ink jet head having the same will be described.

Referring to FIG. 10 and FIG. 11, the piezoelectric element is manufactured by first forming a separate electrode 102 made of platinum (Pt) on a substrate 101 made of a magnesium oxide single crystal (hereinafter referred to as an “MgO substrate”) (step S101). Then, a piezoelectric film 103 made of Pb(Zr,Ti)O₃ is formed on the separate electrode 102 (step S102). Then, the piezoelectric film 103 is patterned by using a strongly acidic solution so as to make the piezoelectric film 103 into a shape that corresponds to individual pressure chambers of the ink jet head. Then, a common electrode 104 is formed on the piezoelectric film 103 (step S103), and a vibration plate 105 made of chromium (Cr) is formed on the common electrode 104 (step S104), thereby obtaining the piezoelectric element including the separate electrode 102, the piezoelectric film 103, the common electrode 104 and the vibration plate 105.

Next, a process of manufacturing the ink jet head using the piezoelectric element will be described. First, following step S104 described above, a body 108 made of a photosensitive glass, in which ink discharge ports 106 and pressure chambers 107 have already been provided, is attached to the vibration plate 105 via an adhesive 110, as illustrated in FIG. 12 and FIG. 13 (step S105). Then, the MgO substrate 101 is dissolved and removed by using a phosphoric acid solution (step S106), and an ink jet head as illustrated in FIG. 13 is formed (step S107).

Note that an ink jet head of this type is disclosed, for example, in Japanese Laid-Open Patent Publication Nos. 10-181016 and 11-348285.

However, with the method for manufacturing a piezoelectric element as described above, the piezoelectric film may be damaged during the step of dissolving and removing the MgO substrate in a phosphoric acid solution (step S106), thereby lowering the voltage endurance or leading to dielectric breakdown occurring upon voltage application. Moreover, an MgO substrate, which is expensive, leads to an increase in the cost of a piezoelectric element.

The present invention, which has been made to solve these problems in the prior art, has an object to improve the voltage endurance of a piezoelectric element while preventing the occurrence of dielectric breakdown, and another object to provide a method for manufacturing a piezoelectric element that is inexpensive.

### SUMMARY OF THE INVENTION

In order to achieve these objects, a method for manufacturing a piezoelectric element of the present invention includes the steps of: layering a layered structure on one surface of a deposition substrate that transmits ultraviolet rays therethrough, the layered structure being a component of the piezoelectric element and including at least a piezoelectric film and a vibration plate; attaching a transfer substrate to the layered structure; and irradiating the other surface of the deposition substrate with ultraviolet rays so as to separate the deposition substrate from the layered structure.

Another method for manufacturing a piezoelectric element of the present invention includes the steps of: forming a piezoelectric film on one surface of a deposition substrate that transmits ultraviolet rays therethrough; forming a second electrode and a vibration plate, in this order, on the piezoelectric film, or forming a vibration plate that functions also as a second electrode on the piezoelectric film; attaching a transfer substrate on the vibration plate; irradiating the other surface of the deposition substrate with ultraviolet rays so as to peel the deposition substrate from the piezoelectric film; and forming a first electrode on the piezoelectric film after the peeling.

With these manufacturing methods, the ultraviolet rays with which the other surface of the deposition substrate is irradiated pass through the deposition substrate but do not pass through the piezoelectric film, whereby the energy of the ultraviolet rays is given to the interface between the deposition substrate and the piezoelectric film. Particularly, since ultraviolet rays can provide local heating, the energy of the ultraviolet rays is localized in the vicinity of the interface. Thus, the coupling between the deposition substrate and the piezoelectric film is broken by the energy, thereby peeling the deposition substrate from the piezoelectric film.

This eliminates the need for dissolving and removing the deposition substrate by exposing it to a phosphoric acid solution, as in the prior art, thus reducing the damage to the piezoelectric film, and maintaining a good film quality of the piezoelectric film. Moreover, since the deposition substrate is not dissolved, it may be reused.

Another method for manufacturing a piezoelectric element of the present invention includes the steps of: forming a conductive film on one surface of a deposition substrate that transmits ultraviolet rays therethrough; forming a piezoelectric film on the conductive film; forming a second electrode and a vibration plate, in this order, on the piezoelectric film, or forming a vibration plate that functions also as a second electrode on the piezoelectric film; attaching a transfer substrate on the vibration plate; irradiating the other surface of the deposition substrate with ultraviolet rays so as to peel the deposition substrate, together with the conductive film, from the piezoelectric film; and forming a first electrode on the piezoelectric film.

With this manufacturing method, an energy is given to the interface between the conductive film and the piezoelectric film by the ultraviolet rays with which the other surface of the deposition substrate is irradiated. In this process, the energy of the ultraviolet rays is made uniform by the conductive film. Therefore, the energy of the ultraviolet rays is given uniformly to the surface of the piezoelectric film. Thus, the deposition substrate is peeled from the piezoelectric film uniformly, thereby further improving the film quality of the piezoelectric film.

The conductive film may be a metal film.

If the thickness is excessively small, the film is formed in an island-like shape, and it is difficult to obtain a film with a good shape. On the other hand, if the thickness is excessively large, the amount of ultraviolet rays to be transmitted is reduced. In view of this, it is preferred that the conductive film is a metal film having a thickness of 1 nm to 300 nm.

The conductive film may be a metal film that has a thickness of 1 nm to 300 nm and whose main component is platinum.

Still another method for manufacturing a piezoelectric element of the present invention includes the steps of: forming an ultraviolet absorbing film that absorbs light whose wavelength is 350 nm or less on one surface of a deposition substrate that transmits ultraviolet rays therethrough; forming a first electrode on the ultraviolet absorbing film; forming a piezoelectric film on the first electrode; forming a second electrode and a vibration plate, in this order, on the piezoelectric film, or forming a vibration plate that functions also as a second electrode on the piezoelectric film; attaching a transfer substrate on the vibration plate; and irradiating the other surface of the deposition substrate with ultraviolet rays so as to peel the deposition substrate, together with the ultraviolet absorbing film, from the first electrode.

With this manufacturing method, the ultraviolet absorbing film and the first electrode are provided between the deposition substrate and the piezoelectric film, and the ultraviolet absorbing film and the first electrode are peeled, thereby eliminating the need for additionally providing a first electrode on the piezoelectric film after the peeling. Therefore, it is possible to further improve the film quality of the piezoelectric film.

The ultraviolet absorbing film may be an oxide film made of an oxide having a perovskite structure or a titanium oxide.

The first electrode may be a metal film containing platinum.

It is preferred that the deposition substrate is made of magnesium oxide, aluminum oxide or quartz.

In this way, the deposition substrate can transmit ultraviolet rays therethrough in a desirable manner during the ultraviolet irradiation process. Moreover, it is possible to ensure a large piezoelectric constant of the piezoelectric film.

The piezoelectric film may be made of an oxide having a perovskite structure whose main component is lead.

It is preferred that: the piezoelectric film has a perovskite structure containing lead, zirconium and titanium; and a lead content of the piezoelectric film is smaller in an area close to the transfer substrate than in another area away from the transfer substrate.

In this way, the piezoelectric film can be peeled in a desirable manner.

Moreover, the piezoelectric film may have a perovskite structure containing lead, zirconium and titanium; and a zirconium content of the piezoelectric film may be greater in an area close to the transfer substrate than in another area away from the transfer substrate.

In this way, the piezoelectric film can be peeled in a desirable manner.

It is preferred that the piezoelectric film has (001) or (111) preferred orientation.

This facilitates the piezoelectric film to uniformly absorb ultraviolet rays in the film thickness direction during the ultraviolet irradiation process.

The vibration plate may be a metal film containing chromium and having a thickness of 0.5 μm to 10 μm.

In this way, it is possible to suppress a crack occurring in the piezoelectric film during the ultraviolet irradiation process. Moreover, it is possible to obtain good characteristics when the piezoelectric element is used as an actuator of an ink jet head.

The ultraviolet rays to be radiated may be of excimer laser light whose wavelength is 150 nm to 350 nm.

Moreover, the ultraviolet rays to be radiated may be of excimer laser light having a pulse width of 50×10⁻⁹ sec or less and an energy density of 0.1 J/cm² to 5 J/cm².

In this way, it is possible to, for example, peel the piezoelectric film from the deposition substrate in a desirable manner.

In a case where a plurality of piezoelectric elements are manufactured simultaneously or successively, it may not be possible to irradiate all the piezoelectric elements with ultraviolet rays at the same time due to the limited ultraviolet irradiation area.

In view of this, during the ultraviolet irradiation process, a location from which the ultraviolet rays are radiated may be moved, or an object to be irradiated may be moved.

In this way, a plurality of piezoelectric elements can be manufactured simultaneously or successively.

A piezoelectric element of the present invention is obtained by: layering a layered structure on one surface of a deposition substrate that transmits ultraviolet rays therethrough, the layered structure being a component of the piezoelectric element and including at least a piezoelectric film and a vibration plate; attaching a transfer substrate to the layered structure; and irradiating the other surface of the deposition substrate with ultraviolet rays so as to separate the deposition substrate from the layered structure.

Another piezoelectric element of the present invention is obtained by: forming a piezoelectric film on one surface of a deposition substrate that transmits ultraviolet rays therethrough; forming a second electrode and a vibration plate, in this order, on the piezoelectric film, or forming a vibration plate that functions also as a second electrode on the piezoelectric film; attaching a transfer substrate on the vibration plate; irradiating the other surface of the deposition substrate with ultraviolet rays so as to peel the deposition substrate from the piezoelectric film; and forming a first electrode on the piezoelectric film after the peeling.

Still another piezoelectric element of the present invention is obtained by: forming a conductive film on one surface of a deposition substrate that transmits ultraviolet rays therethrough; forming a piezoelectric film on the conductive film; forming a second electrode and a vibration plate, in this order, on the piezoelectric film, or forming a vibration plate that functions also as a second electrode on the piezoelectric film; attaching a transfer substrate on the vibration plate; irradiating the other surface of the deposition substrate with ultraviolet rays so as to peel the deposition substrate, together with the conductive film, from the piezoelectric film; and forming a first electrode on the piezoelectric film.

The conductive film may be a metal film.

Moreover, the conductive film may be a metal film having a thickness of 1 nm to 300 nm.

The conductive film may be a metal film that has a thickness of 1 nm to 300 nm and whose main component is platinum.

Still another piezoelectric element of the present invention is obtained by: forming an ultraviolet absorbing film that absorbs light whose wavelength is 350 nm or less on one surface of a deposition substrate that transmits ultraviolet rays therethrough; forming a first electrode on the ultraviolet absorbing film; forming a piezoelectric film on the first electrode; forming a second electrode and a vibration plate, in this order, on the piezoelectric film, or forming a vibration plate that functions also as a second electrode on the piezoelectric film; attaching a transfer substrate on the vibration plate; and irradiating the other surface of the deposition substrate with ultraviolet rays so as to peel the deposition substrate, together with the ultraviolet absorbing film, from the first electrode.

The ultraviolet absorbing film may be an oxide film made of an oxide having a perovskite structure or a titanium oxide.

The first electrode may be a metal film containing platinum.

The deposition substrate may be made of magnesium oxide, aluminum oxide or quartz.

The piezoelectric film may be made of an oxide having a perovskite structure whose main component is lead.

The piezoelectric film may have a perovskite structure containing lead, zirconium and titanium; and a lead content of the piezoelectric film may be smaller in an area close to the transfer substrate than in another area away from the transfer substrate.

The piezoelectric film may have a perovskite structure containing lead, zirconium and titanium; and a zirconium content of the piezoelectric film may be greater in an area close to the transfer substrate than in another area away from the transfer substrate.

The piezoelectric film may have (001) or (111) preferred orientation.

The vibration plate may be a metal film containing chromium and having a thickness of 0.5 μm to 10 μm.

The ultraviolet rays to be radiated may be of excimer laser light whose wavelength is 150 nm to 350 nm.

The ultraviolet rays to be radiated may be of excimer laser light having a pulse width of 50×10⁻⁹ sec or less and an energy density of 0.1 J/cm² to 5 J/cm².

During the ultraviolet irradiation process, a location from which the ultraviolet rays are radiated may be moved, or an object to be irradiated may be moved.

An ink jet head of the present invention includes: a body including an ink discharge port and a pressure chamber communicated to the ink discharge port; and any of the piezoelectric elements described above which is provided on the body so that the pressure chamber is covered by the vibration plate.

An ink jet recording apparatus of the present invention includes: the ink jet head described above; and movement means for relatively moving the ink jet head and a recording medium with respect to each other.

As described above, the present invention provides the following effects.

Since the piezoelectric film, etc., is separated from the deposition substrate by the ultraviolet irradiation, the piezoelectric film can be transferred onto the transfer substrate without dissolving and removing the deposition substrate. It is possible to manufacture a piezoelectric film with reduced damage, and it is possible to obtain a piezoelectric element that has reduced voltage endurance defect and is inexpensive.

It is possible to obtain an ink jet head and an ink jet recording apparatus with a high reliability by using a piezoelectric element having a good voltage endurance.

### BRIEF DESCRIPTION OF THE DRAWINGS

FIG. 1 is a flow chart illustrating steps in a method for manufacturing a piezoelectric element and an ink jet head according to Embodiment 1 of the present invention.

FIG. 2 is a cross-sectional view of the piezoelectric element, illustrating the method for manufacturing a piezoelectric element according to Embodiment 1 of the present invention.

FIG. 3 is a cross-sectional view illustrating the piezoelectric element according to Embodiment 1 of the present invention.

FIG. 4 is a cross-sectional view of an ink jet head according to Embodiment 1 of the present invention.

FIG. 5 is a perspective view illustrating an important part of a printer according to Embodiment 1 of the present invention.

FIG. 6 is a flow chart illustrating steps in a method for manufacturing a piezoelectric element and an ink jet head according to Embodiment 2 of the present invention.

FIG. 7 is a cross-sectional view of the piezoelectric element, illustrating the method for manufacturing a piezoelectric element according to Embodiment 2 of the present invention.

FIG. 8 is a flow chart illustrating steps in a method for manufacturing a piezoelectric element and an ink jet head according to Embodiment 3 of the present invention.

FIG. 9 is a cross-sectional view illustrating the piezoelectric element according to Embodiment 3 of the present invention.

FIG. 10 is a flow chart illustrating steps in a conventional method for manufacturing a piezoelectric element and an ink jet head.

FIG. 11 is a cross-sectional view of the piezoelectric element, illustrating the conventional method for manufacturing a piezoelectric element.

FIG. 12 is a cross-sectional view of the piezoelectric element, illustrating the conventional method for manufacturing a piezoelectric element.

FIG. 13 is a cross-sectional view illustrating a conventional ink jet head.

### DESCRIPTION OF THE PREFERRED EMBODIMENTS

Embodiments of the present invention will now be described with reference to the drawings.

Embodiment 1

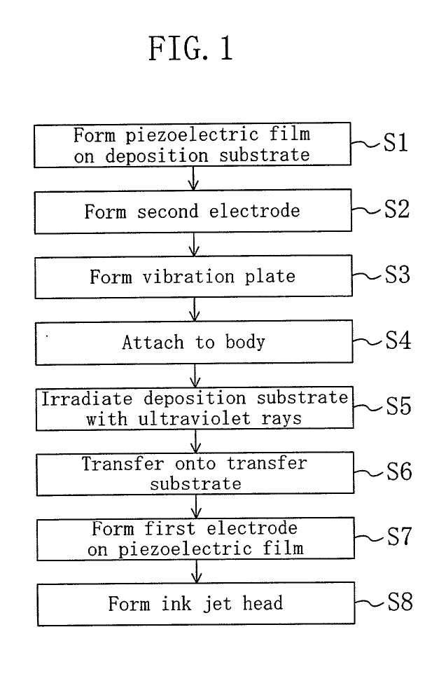

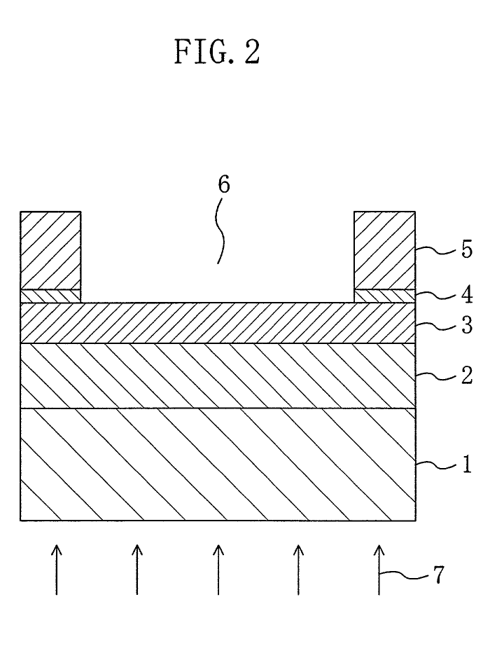

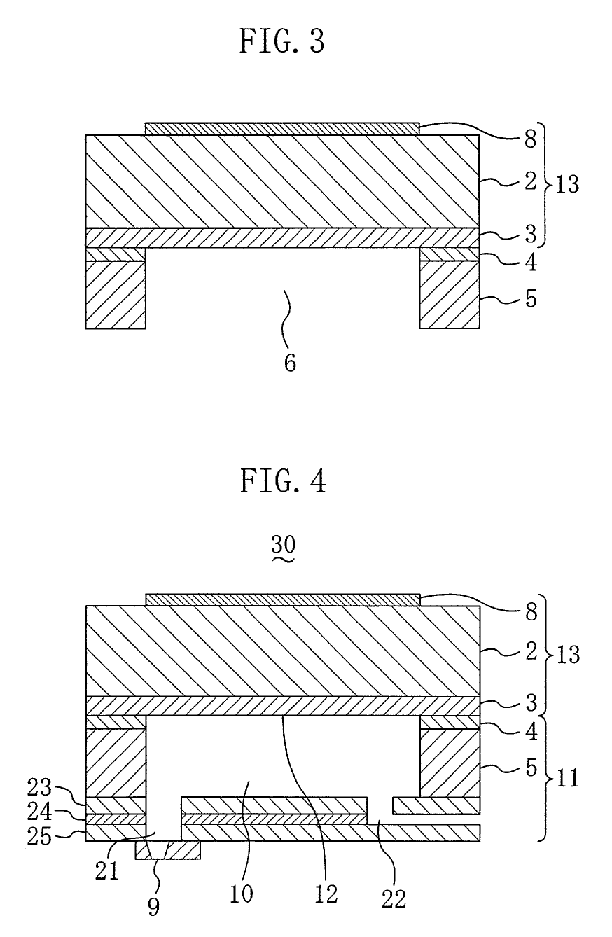

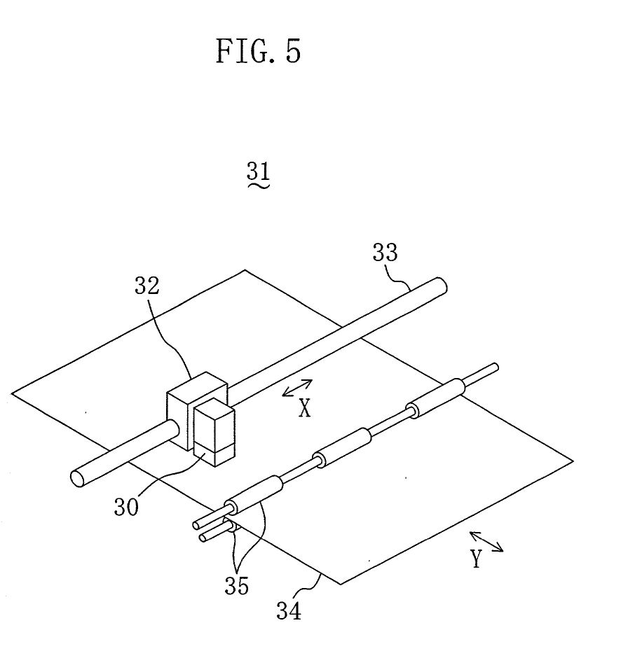

Embodiment 1 of the present invention will now be described with reference to FIG. 1 to FIG. 5. FIG. 1 is a flow chart illustrating steps in a method for manufacturing a piezoelectric element and an ink jet head according to Embodiment 1 of the present invention, FIG. 2 is a cross-sectional view illustrating the piezoelectric element being manufactured, and FIG. 3 is a cross-sectional view illustrating the piezoelectric element. FIG. 4 is a cross-sectional view illustrating a portion of the ink jet head, and FIG. 5 is a perspective view schematically illustrating an important part of an ink jet recording apparatus.

In the present embodiment, a piezoelectric element and an ink jet head were manufactured as follows. First, a single crystal magnesium oxide (MgO) substrate was prepared as a deposition substrate 1 that transmits ultraviolet rays therethrough. The MgO substrate was obtained by cleaving a crystal along the (100) plane and then polishing both sides thereof in order to reduce the scattering of ultraviolet rays occurring during an ultraviolet irradiation process to be described later. Note that the deposition substrate 1 may be any type of substrate that transmits ultraviolet rays therethrough, and is not limited to any particular type of substrate. Note however that a piezoelectric film is to be formed on the substrate 1, and therefore the material of the deposition substrate 1 is preferably suitable for the formation of a piezoelectric film having a large piezoelectric constant. The material of the deposition substrate 1 may be MgO or other materials well known in the art with which a large piezoelectric constant of the piezoelectric film can be ensured.

Then, a piezoelectric film 2 having a thickness of 3 μm was formed on one surface of the deposition substrate 1 (step S1). Herein, a Pb(Zr₅₃Ti₄₇)O₃ film was formed as the piezoelectric film 2. Pb(Zr₅₃Ti₄₇)O₃ (hereinafter referred to as “PZT”) is an oxide having a perovskite structure whose main component is lead (Pb), which has (001) preferred orientation, and which absorbs ultraviolet rays. Note that the piezoelectric film 2 was formed by a sputtering method, and the deposition substrate 1 was heated to a temperature of 600° C. during the process.

Then, a second electrode and vibration plate 3, being made of chromium (Cr) having a thickness of 3.5 μm and functioning both as a second electrode and as a vibration plate, was formed on the piezoelectric film 2 by a sputtering method (step S2 and step S3).

Then, the second electrode and vibration plate 3 and a transfer substrate 5 were attached together by using a resin 4 as an adhesive (step S4). Note that a photosensitive glass, in which a through hole 6 had already been formed in an area where the second electrode and vibration plate 3 vibrates, was used for the transfer substrate 5.

Then, as illustrated in FIG. 2, the other surface of the deposition substrate 1 was irradiated with ultraviolet rays 7 of excimer laser having an energy density of 0.5 J/cm² and a pulse width of 30×10⁻⁹ sec (step S5). In this way, the ultraviolet rays 7 pass through the deposition substrate 1 but do not pass through the piezoelectric film 2, whereby the energy of the ultraviolet rays 7 is given to the interface between the deposition substrate 1 and the piezoelectric film 2. Thus, peeling occurs between the deposition substrate 1 and the piezoelectric film 2, and the deposition substrate 1 is separated from the piezoelectric film 2. As a result, the piezoelectric film 2 and the second electrode and vibration plate 3 remain on the transfer substrate 5, thus transferring the piezoelectric film 2 and the second electrode and vibration plate 3 onto the transfer substrate 5 (step S6).

Then, as illustrated in FIG. 3, a first electrode 8 having been separated into individual pieces was formed on the piezoelectric film 2 after the peeling (step S7), thereby obtaining a piezoelectric element 13 having, as its component, a layered structure including the first electrode 8, the piezoelectric film 2 and the second electrode and vibration plate 3.

The voltage endurance defect rate of the piezoelectric element 13 of the present embodiment was measured by applying a voltage of 100 V, and the rate was 13%, indicating a significantly lower rate with respect to that in the prior art (78%). This is because in the present embodiment, the film quality of the piezoelectric film does not deteriorate as does in the prior art. Specifically, it was not easy with conventional techniques to determine the timing of dissolution/removal of the deposition substrate 1, and the deposition substrate 1 was likely to be dissolved in a non-uniform manner. Thus, some of the piezoelectric films had their film quality deteriorated through the exposure to an etchant. In contrast, such a deterioration in the film quality does not occur in the present embodiment.

Note that in the present embodiment, the deposition substrate 1, which has been peeled from the piezoelectric film 2 through the ultraviolet irradiation, can be reused after polishing or etching the surface thereof. Therefore, the manufacturing cost can be reduced by the reuse of the deposition substrate 1.

Next, an ink jet head 30 having the piezoelectric element 13 as an actuator will be described.

FIG. 4 is a cross-sectional view illustrating a portion of the ink jet head 30 according to Embodiment 1 of the present invention. The ink jet head 30, including the piezoelectric element 13 and a body 11, is produced by using the piezoelectric element 13 (step S8).

The body 11 includes the transfer substrate 5, which defines pressure chambers 10, and layered plates 23 to 25, which define an ink channel 21 connecting the pressure chamber 10 and an ink discharge port 9 to each other and an ink channel 22 connecting the pressure chamber 10 and a common ink chamber (not shown) to each other. A portion of the body 11 corresponding to the pressure chamber 10 forms a vibrating portion 12 for causing a flexural deformation in the second electrode and vibration plate 3 of the piezoelectric element 13.

The piezoelectric element 13 is attached to the body 11 via the resin 4. More specifically, the piezoelectric element 13 is attached to a portion of the body 11 around the vibrating portion 12.

In a recording operation, an AC voltage is applied between the first electrode 8 and the second electrode and vibration plate 3 of the ink jet head 30 so as to cause a flexural deformation in the second electrode and vibration plate 3 by the piezoelectric effect of the piezoelectric film 2. The flexural deformation in the second electrode and vibration plate 3 pressurizes the ink in the pressure chamber 10 to discharge the ink from the ink discharge port 9.

Note that for ink jet heads using conventional piezoelectric elements, a discharge defect occurred in 15% of the piezoelectric elements after applying an AC voltage of 30 V having a frequency of 10 kHz as a driving signal for the piezoelectric elements for 10 days. In contrast, an ink jet head of the present embodiment did not experience a discharge defect and the vibration characteristic thereof did not substantially lower.

FIG. 5 illustrates a general structure of an ink jet printer 31 using the ink jet head 30 therein. The ink jet head 30 is fixed to a carriage 32 that is provided with a carriage motor (not shown). The carriage 32 is reciprocally moved by the carriage motor in a primary scanning direction X while being guided by a carriage shaft that extends in the primary scanning direction X. Therefore, the ink jet head 30 is also reciprocally moved in the primary scanning direction X.

Recording paper 34 is sandwiched between two carrier rollers 35 rotated by a carrier motor (not shown), and is carried in a secondary scanning direction Y perpendicular to the primary scanning direction X by the carrier motor and the carrier rollers 35.

Note however that the recording apparatus of the present invention is not limited to the printer 31 as described above, but the present invention may alternatively be applied to other types of printers. Moreover, the recording apparatus of the present invention is not limited to a printer, but may alternatively be any other type of recording apparatus having an ink jet head therein, such as a copier or a facsimile.

Embodiment 2

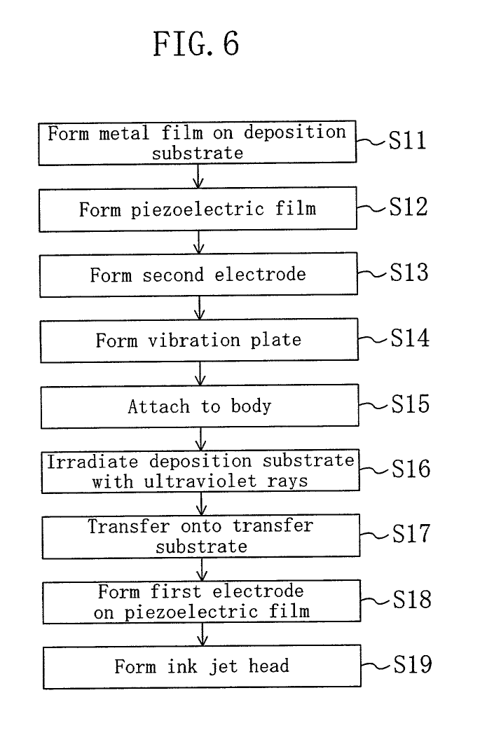

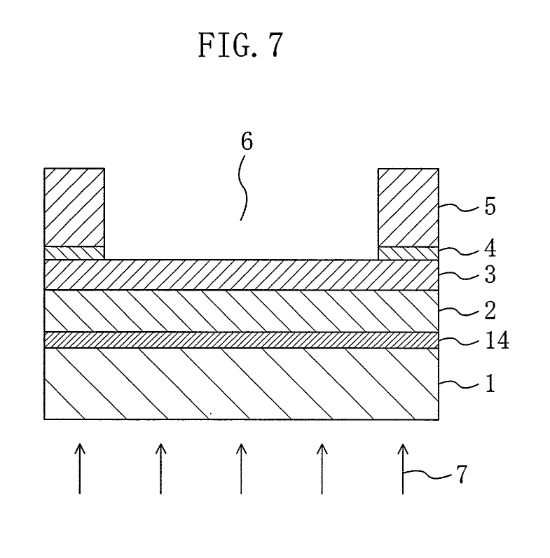

Embodiment 2 of the present invention will now be described with reference to FIG. 6 and FIG. 7. FIG. 6 is a flow chart illustrating steps in a method for manufacturing a piezoelectric element and an ink jet head according to Embodiment 2 of the present invention, and FIG. 7 is a cross-sectional view illustrating the piezoelectric element of Embodiment 2 being manufactured.

In the present embodiment, first, a metal film 14 having a thickness of 50 nm and made of platinum was formed by a sputtering method on the deposition substrate 1 made of single crystal MgO as in Embodiment 1 (step S11).

Then, the piezoelectric film 2 having a thickness of 3 μm and made of PZT was formed on the metal film 14 by a sputtering method as in Embodiment 1 (step S12). Then, the second electrode and vibration plate 3, being made of Cr having a thickness of 3.5 μm and functioning both as an electrode and as a vibration plate, was formed by a sputtering method as in Embodiment 1 (step S13 and step S14).

Then, the second electrode and vibration plate 3 was attached to the transfer substrate 5 by using the resin 4 (step S15). Note that a photosensitive glass, in which the through hole 6 had already been formed, was used for the transfer substrate 5 as in Embodiment 1.

Then, as illustrated in FIG. 7, the other surface of the deposition substrate 1 was irradiated with the ultraviolet rays 7 of KrF excimer laser having an energy density of 0.8 J/cm² and a pulse width of 30×10⁻⁹ sec (step S16). In this way, the ultraviolet rays passed through the deposition substrate 1 and the metal film 14 and were absorbed by the piezoelectric film 2, whereby peeling occurred at the interface between the metal film 14 and the piezoelectric film 2, thus separating the metal film 14 and the deposition substrate 1 from the piezoelectric film 2. Thus, the piezoelectric film 2 and the second electrode and vibration plate 3 were transferred onto the transfer substrate 5 (step S17).

Note that the piezoelectric elements produced by the method of the present embodiment had a voltage endurance defect rate of 8%, which is lower than that of Embodiment 1. It is believed that such a result was obtained because the metal film 14 having a good conductivity was provided on the piezoelectric film 2, thereby giving the energy of ultraviolet rays uniformly onto the piezoelectric film 2 via the metal film 14. Specifically, while the energy distribution of the radiated ultraviolet rays is normally non-uniform, the energy distribution is made uniform in the present embodiment by the metal film 14. It is believed that the distribution of the energy given to the interface between the metal film 14 and the piezoelectric film 2 was thus made uniform, thereby peeling the piezoelectric film 2 in a desirable manner. Therefore, according to the present embodiment, the film quality of the piezoelectric film 2 is maintained at an even better level.

While platinum having a thickness of 50 nm was used as the metal film 14 in the present embodiment, effects as those of the present embodiment can be obtained as long as at least the main component of the material of the metal film 14 is platinum and the thickness thereof is 1 nm to 300 nm. Moreover, a conductive material that transmits ultraviolet rays therethrough, e.g., a ruthenium oxide, ITO, etc., may be used instead of the metal film 14.

Note that the ink jet head using the piezoelectric element of the present embodiment did not experience an ink discharge defect and the vibration characteristic thereof did not substantially lower even after applying an AC voltage of 30 V having a frequency of 10 kHz for 18 days.

Embodiment 3

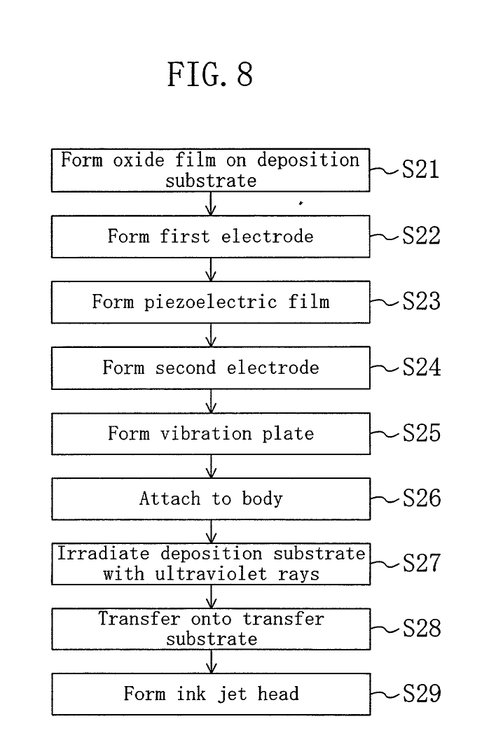

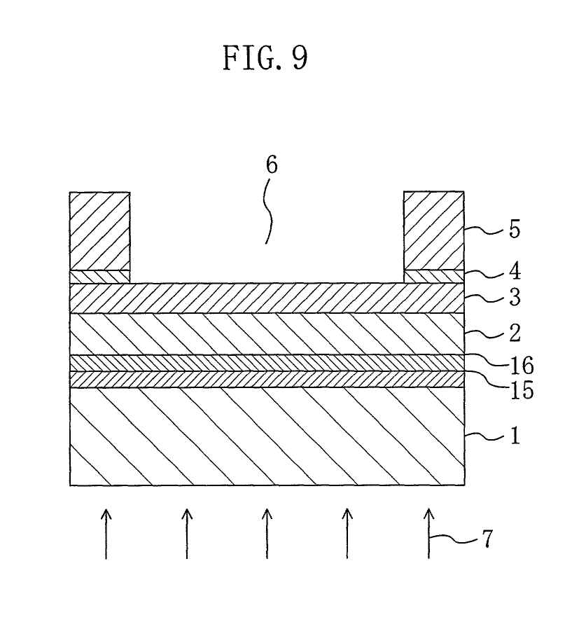

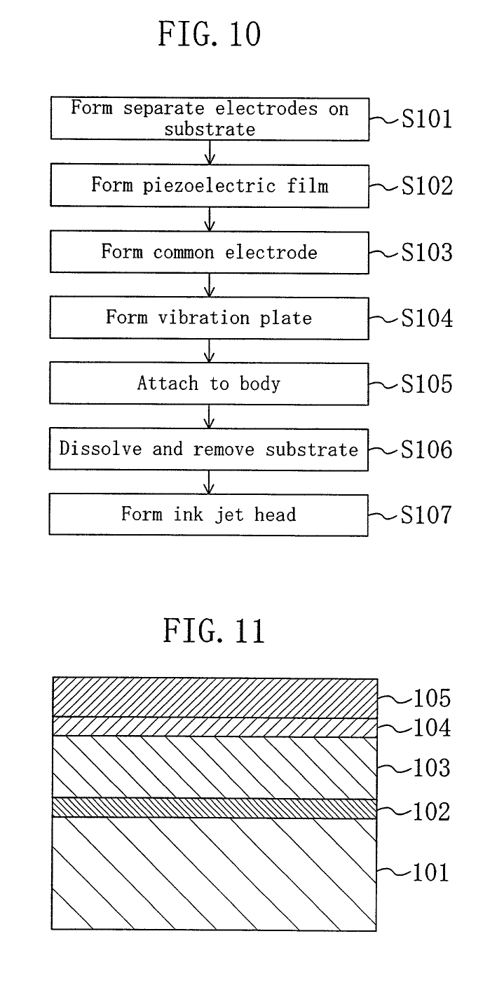

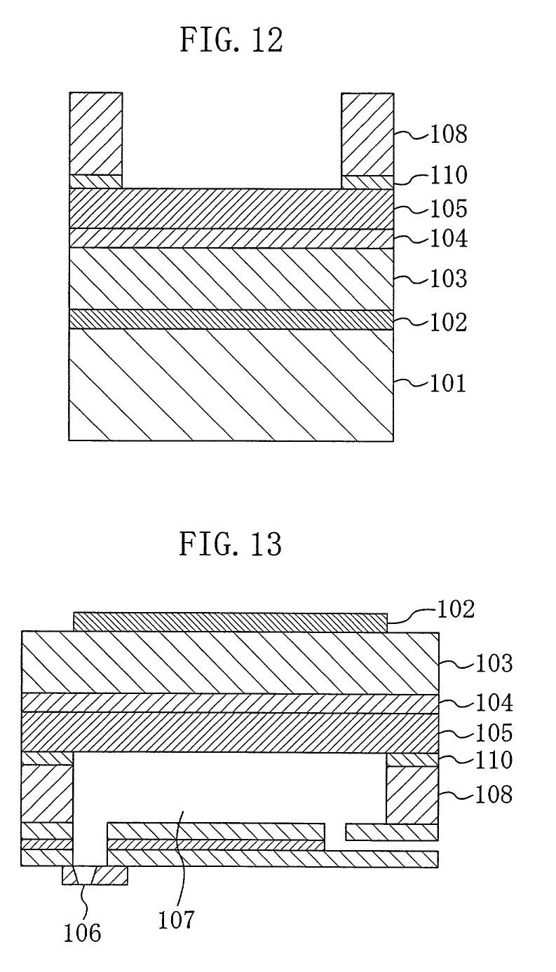

Embodiment 3 of the present invention will now be described with reference to FIG. 8 and FIG. 9. FIG. 8 is a flow chart illustrating steps in a method for manufacturing a piezoelectric element and an ink jet head according to Embodiment 3 of the present invention, and FIG. 9 is a cross-sectional view illustrating the piezoelectric element of Embodiment 3.

First, an oxide film 15 having a thickness of about 0.2 μm was formed by a sputtering method on the deposition substrate 1 made of single crystal MgO as in Embodiment 1 (step S21). Herein, an oxide having a perovskite structure with about 10% of Pb in PbTiO₃ being substituted by lanthanum (La) (hereinafter referred to as “PLT”) was used for the oxide film 15. Note that the oxide film 15 absorbs light whose wavelength is 350 nm or less.

Then, a first electrode 16 made of platinum having a thickness of about 0.1 μm was formed on the oxide film 15 by a sputtering method (step S22).

Then, the piezoelectric film 2 made of PZT having a thickness of 3 μm was formed on the first electrode 16 by a sputtering method as in Embodiment 1 (step S23).

Then, the second electrode and vibration plate 3, being made of Cr having a thickness of 3.5 μm and functioning both as an electrode and as a vibration plate, was formed on the piezoelectric film 2 by a sputtering method as in Embodiment 1 (step S24 and step S25).

Furthermore, the second electrode and vibration plate 3 was attached to the transfer substrate 5 by using the resin 4 (step S26). Note that a photosensitive glass, in which the through hole 6 had already been formed, was used for the transfer substrate 5.

Then, as illustrated in FIG. 9, the other surface of the deposition substrate 1 was irradiated with the ultraviolet rays 7 of KrF excimer laser having an energy density of 0.5 J/cm² and a pulse width of 30×10⁻⁹ sec (step S27). In this way, the ultraviolet rays passed through the deposition substrate 1 and were completely absorbed by the oxide film 15, whereby peeling occurred at the interface between the first electrode 16 and the oxide film 15, thus transferring the first electrode 16, the piezoelectric film 2 and the second electrode and vibration plate 3 onto the transfer substrate 5 (step S28).

Note that the piezoelectric elements produced by this method had a voltage endurance defect rate of 5%, which is lower than those of the prior art and those of the embodiments described above.

Moreover, the ink jet head using the piezoelectric element of the present embodiment did not experience an ink discharge defect and the vibration characteristic thereof did not substantially lower even after applying an AC voltage of 30 V having a frequency of 10 kHz for 27 days.

Note that effects as those described above can be obtained alternatively by using, as the ultraviolet rays absorbing film, an oxide film that absorbs light whose wavelength is 350 nm or less, e.g., an oxide film having a perovskite structure such as SrTiO₃ or a titanium oxide (TiO₂) film, instead of a PLT film.

Incidentally, it has been empirically found that in a case where a PZT film is used as the piezoelectric film, the peeling of the piezoelectric film from the deposition substrate is easier as a greater amount of a lead component is contained in an area in the vicinity of the interface between the piezoelectric film and the deposition substrate 1. In view of this, it is preferred that a piezoelectric film that has a perovskite structure containing lead, zirconium and titanium and whose lead content is smaller in an area close to the transfer substrate than in other areas is used as the piezoelectric film, instead of using PZT having a uniform composition. In other words, it is preferred to use a piezoelectric film having a composition distribution such that the lead content in an area close to the deposition substrate before being separated is greater than the lead content in other areas. In order to obtain such a composition distribution, the lead content may be controlled to decrease toward the transfer substrate either continuously or in a stepwise manner (i.e., by combining together a number of PZT layers of different compositions).

Moreover, it has been empirically found that if the zirconium content is increased locally at a location in PZT, the lead content at that location decreases accordingly. In view of this, a piezoelectric film that has a perovskite structure containing lead, zirconium and titanium and whose zirconium content is greater in an area close to the transfer substrate than in other areas may be used as the piezoelectric film, instead of using PZT having a uniform composition. In other words, a piezoelectric film having a composition distribution such that the zirconium content in an area close to the deposition substrate before being separated is smaller than the zirconium content in other areas may be used. Note that in order to obtain such a composition distribution, the zirconium content may be controlled to increase toward the transfer substrate either continuously or in a stepwise manner (i.e., by combining together a number of PZT layers of different compositions).

Aluminum oxide or quartz may be used, instead of magnesium oxide, for the deposition substrate that transmits ultraviolet rays therethrough. Also in such a case, effects as those of the embodiments described above can be obtained. Furthermore, the piezoelectric film may have (111) preferred orientation. Also in such a case, as in the case where it has (001) preferred orientation, it is possible to obtain the effect of uniformly absorbing ultraviolet rays in the film thickness direction.

It is particularly preferred to use chromium having a thickness of 0.5 μm to 10 μm for the vibration plate. This is because it is then possible to effectively suppress a crack occurring in the piezoelectric film during the ultraviolet irradiation process due to the high rigidity of chromium, and because it is then possible to obtain good characteristics as an actuator of an ink jet head.

Furthermore, it is preferred that the ultraviolet rays to be radiated are of excimer laser light whose wavelength is 150 nm to 350 nm. It is particularly preferred that the wavelength is set to be 350 nm or less, in which case the ultraviolet rays can be sufficiently absorbed by the piezoelectric film. In this way, it is possible to radiate a sufficiently strong energy for peeling the deposition substrate from the piezoelectric film. Furthermore, it is particularly preferred that the pulse width is set to be 50×10⁻⁹ sec or less while the energy is set to be 0.1 J/cm² to 5 J/cm², in which case the piezoelectric film in contact with the deposition substrate can be rapidly heated and cooled. In this way, the possible damage in the piezoelectric film due to the irradiation can be limited to a very small area.

Each piezoelectric element is separately irradiated with ultraviolet rays in the embodiments described above. Alternatively, a plurality of piezoelectric elements may be produced and irradiated with ultraviolet rays simultaneously or successively. For example, with a number of piezoelectric elements being formed on a single deposition substrate, the light source itself that radiates ultraviolet rays, or the direction of the ultraviolet radiation, may be moved with respect to the piezoelectric elements. Conversely, an object to be irradiated (including a deposition substrate, a piezoelectric film, an electrode, a vibration plate and a transfer substrate layered together) may be moved while it is irradiated with ultraviolet rays.

In the embodiments described above, the second electrode and vibration plate 3, which functions both as a second electrode and a vibration plate, is layered on the piezoelectric film 2 as an integrated component. However, it is of course possible to provide a second electrode and a vibration plate by using different materials. Specifically, a second electrode and a vibration plate may be layered, in this order, on the piezoelectric film 2.

The present invention is not limited to the embodiments set forth above, but may be carried out in various other ways without departing from the sprit or main features thereof.

Thus, the embodiments set forth above are merely illustrative in every respect, and should not be taken as limiting. The scope of the present invention is defined by the appended claims, and in no way is limited to the description set forth herein. Moreover, any variations and/or modifications that are equivalent in scope to the claims fall within the scope of the present invention.

What is claimed is:

1. A method for manufacturing a piezoelectric element, comprising the steps of: layering a layered structure on one surface of a deposition substrate that transmits ultraviolet rays therethrough, the layered structure being a component of the piezoelectric element and including at least a piezoelectric film and a vibration plate; attaching a transfer substrate to the layered structure; and irradiating the other surface of the deposition substrate with ultraviolet rays so as to separate the deposition substrate from the layered structure.

2. The method for manufacturing a piezoelectric element of claim 1, comprising the steps of:
forming a piezoelectric film on one surface of a deposition substrate that transmits ultraviolet rays therethrough;
forming a second electrode and a vibration plate, in this order, on the piezoelectric film, or forming a vibration plate that functions also as a second electrode on the piezoelectric film;
attaching a transfer substrate on the vibration plate;
irradiating the other surface of the deposition substrate with ultraviolet rays so as to peel the deposition substrate from the piezoelectric film; and
forming a first electrode on the piezoelectric film after the peeling.

3. The method for manufacturing a piezoelectric element of claim 1, comprising the steps of:
forming a conductive film on one surface of a deposition substrate that transmits ultraviolet rays therethrough;
forming a piezoelectric film on the conductive film;
forming a second electrode and a vibration plate, in this order, on the piezoelectric film, or forming a vibration plate that functions also as a second electrode on the piezoelectric film;
attaching a transfer substrate on the vibration plate;
irradiating the other surface of the deposition substrate with ultraviolet rays so as to peel the deposition substrate, together with the conductive film, from the piezoelectric film; and
forming a first electrode on the piezoelectric film.

4. The method for manufacturing a piezoelectric element of claim 3, wherein the conductive film is a metal film.

5. The method for manufacturing a piezoelectric element of claim 3, wherein the conductive film is a metal film having a thickness of 1 nm to 300 nm.

6. The method for manufacturing a piezoelectric element of claim 3, wherein the conductive film is a metal film that has a thickness of 1 nm to 300 nm and whose main component is platinum.

7. The method for manufacturing a piezoelectric element of claim 1, comprising the steps of:
forming an ultraviolet absorbing film that absorbs light whose wavelength is 350 nm or less on one surface of a deposition substrate that transmits ultraviolet rays therethrough;
forming a first electrode on the ultraviolet absorbing film;
forming a piezoelectric film on the first electrode;
forming a second electrode and a vibration plate, in this order, on the piezoelectric film, or forming a vibration plate that functions also as a second electrode on the piezoelectric film;
attaching a transfer substrate on the vibration plate; and
irradiating the other surface of the deposition substrate with ultraviolet rays so as to peel the deposition substrate, together with the ultraviolet absorbing film, from the first electrode.

8. The method for manufacturing a piezoelectric element of claim 8, wherein the ultraviolet absorbing film is an oxide film made of an oxide having a perovskite structure or a titanium oxide.

9. The method for manufacturing a piezoelectric element of claim 7, wherein the first electrode is a metal film containing platinum.

10. The method for manufacturing a piezoelectric element of claim 1, wherein the deposition substrate is made of magnesium oxide, aluminum oxide or quartz.

11. The method for manufacturing a piezoelectric element of claim 1, wherein the piezoelectric film is made of an oxide having a perovskite structure whose main component is lead.

12. The method for manufacturing a piezoelectric element of claim 1, wherein:
the piezoelectric film has a perovskite structure containing lead, zirconium and titanium; and
a lead content of the piezoelectric film is smaller in an area close to the transfer substrate than in another area away from the transfer substrate.

13. The method for manufacturing a piezoelectric element of claim 1, wherein:
the piezoelectric film has a perovskite structure containing lead, zirconium and titanium; and
a zirconium content of the piezoelectric film is greater in an area close to the transfer substrate than in another area away from the transfer substrate.

14. The method for manufacturing a piezoelectric element of claim 1, wherein the piezoelectric film has (001) or (111) preferred orientation.

15. The method for manufacturing a piezoelectric element of claim 1, wherein the vibration plate is a metal film containing chromium and having a thickness of 0.5 μm to 10 μm.

16. The method for manufacturing a piezoelectric element of claim 1, wherein the ultraviolet rays to be radiated are of excimer laser light whose wavelength is 150 nm to 350 nm.

17. The method for manufacturing a piezoelectric element of claim 1, wherein the ultraviolet rays to be radiated are of excimer laser light having a pulse width of 50×10⁻⁹ sec or less and an energy density of 0.1 J/cm² to 5 J/cm².

18. The method for manufacturing a piezoelectric element of claim 1, wherein during the ultraviolet irradiation process, a location from which the ultraviolet rays are radiated is moved, or an object to be irradiated is moved.

19. A piezoelectric element, obtained by: layering a layered structure on one surface of a deposition substrate that transmits ultraviolet rays therethrough, the layered structure being a component of the piezoelectric element and including at least a piezoelectric film and a vibration plate; attaching a transfer substrate to the layered structure; and irradiating the other surface of the deposition substrate with ultraviolet rays so as to separate the deposition substrate from the layered structure.

20. The piezoelectric element of claim 19, obtained by: forming a piezoelectric film on one surface of a deposition substrate that transmits ultraviolet rays therethrough; forming a second electrode and a vibration plate, in this order, on the piezoelectric film, or forming a vibration plate that functions also as a second electrode on the piezoelectric film; attaching a transfer substrate on the vibration plate; irradiating the other surface of the deposition substrate with ultraviolet rays so as to peel the deposition substrate from the piezoelectric film; and forming a first electrode on the piezoelectric film after the peeling.

21. The piezoelectric element of claim 19, obtained by: forming a conductive film on one surface of a deposition substrate that transmits ultraviolet rays therethrough; forming a piezoelectric film on the conductive film; forming a second electrode and a vibration plate, in this order, on the piezoelectric film, or forming a vibration plate that functions also as a second electrode on the piezoelectric film; attaching a transfer substrate on the vibration plate; irradiating the other surface of the deposition substrate with ultraviolet rays so as to peel the deposition substrate, together with the conductive film, from the piezoelectric film; and forming a first electrode on the piezoelectric film.

22. The piezoelectric element of claim 21, wherein the conductive film is a metal film.

23. The piezoelectric element of claim 21, wherein the conductive film is a metal film having a thickness of 1 nm to 300 nm.

24. The piezoelectric element of claim 21, wherein the conductive film is a metal film that has a thickness of 1 nm to 300 nm and whose main component is platinum.

25. The piezoelectric element of claim 19, obtained by: forming an ultraviolet absorbing film that absorbs light whose wavelength is 350 nm or less on one surface of a deposition substrate that transmits ultraviolet rays therethrough; forming a first electrode on the ultraviolet absorbing film; forming a piezoelectric film on the first electrode; forming a second electrode and a vibration plate, in this order, on the piezoelectric film, or forming a vibration plate that functions also as a second electrode on the piezoelectric film; attaching a transfer substrate on the vibration plate; and irradiating the other surface of the deposition substrate with ultraviolet rays so as to peel the deposition substrate, together with the ultraviolet absorbing film, from the first electrode.

26. The piezoelectric element of claim 25, wherein the ultraviolet absorbing film is an oxide film made of an oxide having a perovskite structure or a titanium oxide.

27. The piezoelectric element of claim 25, wherein the first electrode is a metal film containing platinum.

28. The piezoelectric element of claim 19, wherein the deposition substrate is made of magnesium oxide, aluminum oxide or quartz.

29. The piezoelectric element of claim 19, wherein the piezoelectric film is made of an oxide having a perovskite structure whose main component is lead.

30. The piezoelectric element of claim 19, wherein:
the piezoelectric film has a perovskite structure containing lead, zirconium and titanium; and
a lead content of the piezoelectric film is smaller in an area close to the transfer substrate than in another area away from the transfer substrate.

31. The piezoelectric element of claim 19, wherein:
the piezoelectric film has a perovskite structure containing lead, zirconium and titanium; and
a zirconium content of the piezoelectric film is greater in an area close to the transfer substrate than in another area away from the transfer substrate.

32. The piezoelectric element of claim 19, wherein the piezoelectric film has (001) or (111) preferred orientation.

33. The piezoelectric element of claim 19, wherein the vibration plate is a metal film containing chromium and having a thickness of 0.5 μm to 10 μm.

34. The piezoelectric element of claim 19, wherein the ultraviolet rays to be radiated are of excimer laser light whose wavelength is 150 nm to 350 nm.

35. The piezoelectric element of claim 19, wherein the ultraviolet rays to be radiated are of excimer laser light having a pulse width of 50×10⁻⁹ sec or less and an energy density of 0.1 J/cm² to 5 J/cm².

36. The piezoelectric element of claim 19, wherein during the ultraviolet irradiation process, a location from which the ultraviolet rays are radiated is moved, or an object to be irradiated is moved.

37. An ink jet head, comprising: a body including an ink discharge port and a pressure chamber communicated to the ink discharge port; and the piezoelectric element of claim 19 provided on the body so that the pressure chamber is covered by the vibration plate.

38. An ink jet recording apparatus, comprising: the ink jet head of claim 37; and movement means for relatively moving the ink jet head and a recording medium with respect to each other.
